(19) United States
(12) Patent Application Publication
(10) Pub. No.: US 2016/0049213 A1
(43) Pub. Date: Feb. 18, 2016

(54) Neutron Absorber Members, Insertion Apparatus, And Neutron Absorber Member Retainers

(71) Applicant: Curtiss-Wright Flow Control Corporation, Falls Church, VA (US)

(72) Inventors: Matthew Lee Eyre, Ulster Park, NY (US); Karl Scot Leuenroth, Newburgh, NY (US); James Raymond Loeven, JR., Pawling, NY (US)

(21) Appl. No.: 14/458,737

(22) Filed: Aug. 13, 2014

(51) Int. Cl. G21C 19/40; G21C 7/26; G21C 7/06

(52) U.S. Cl. CPC G21C 19/40; G21C 7/06; G21C 7/26

(57) ABSTRACT

Neutron absorber members for a control rod guide tube of a spent fuel assembly are provided as a tube split throughout a length thereof. In further examples, an insertion apparatus for inserting a neutron absorber member into a control rod guide tube of a spent fuel assembly includes an insertion tool base and an insertion tool rod. The insertion tool rod is removably secured within and extending from the insertion tool base according to a position of the control rod guide tube into which the neutron absorber is to be inserted. In further examples, a neutron absorber member retainer for a top nozzle of a spent fuel assembly is provided. The retainer includes a plate configured to inhibit a neutron absorber member inserted in a control rod guide tube from removal.

### BACKGROUND

1. Field

The following description relates to neutron absorber members for a control rod guide tube of a spent fuel assembly, an insertion apparatus for inserting a neutron absorber member into a control rod guide tube of a spent fuel assembly, and a neutron absorber member retainers for a top nozzle of a spent fuel assembly.

2. Description of Related Art

It is known for spent fuel assemblies of nuclear reactors to be stored in pools of water after fuel within the assemblies is depleted. It is additionally known for neutron absorbers to be inserted into control rod guide tubes of the spent fuel assembly to ensure subcriticality of the spent fuel assembly while in the pool.

### SUMMARY

In a first aspect of the disclosure, a neutron absorber member for a control rod guide tube of a spent fuel assembly is a tube split throughout a length thereof.

In one example of the first aspect, the absorber member is composed of a metal matrix composite including boron carbide. An amount of boron carbide in the metal matrix corresponds with a reactivity control provided to the spent fuel assembly by the absorber member.

In another example of the first aspect, a width of the split varies throughout the length of the absorber member according to a shape of the control rod guide tube.

In yet another example of the first aspect, the absorber member comprises a C-shape formed by the split.

In still another example of the first aspect, the absorber member extends substantially throughout a length of the control rod guide tube. In a further example of the first aspect, the absorber member includes a plurality of sections having a combined length that is substantially equivalent to the length of the control rod guide tube.

In an additional example of the first aspect, an insertion apparatus for inserting the neutron absorber member into a control rod guide tube of a spent fuel assembly. The apparatus includes an insertion tool base and an insertion tool rod removably secured within and extending from the insertion tool base according to a position of the control rod guide tube into which the neutron absorber member is to be inserted. The insertion tool rod is configured to hold the neutron absorber member thereon during insertion of the neutron absorber member into the control rod guide tube. The insertion tool rod is further configured to release the neutron absorber member when the neutron absorber member is fully installed in the control rod guide tube and the insertion tool rod is removed from the control rod guide tube.

The first aspect may be provided alone or in combination with one or any combination of the examples of the first aspect discussed above.

In a second aspect of the disclosure, an insertion apparatus is provided for inserting a neutron absorber member into a control rod guide tube of a spent fuel assembly. The apparatus includes an insertion tool base and an insertion tool rod removably secured within and extending from the insertion tool base according to a position of the control rod guide tube into which the neutron absorber member is to be inserted. The insertion tool rod is configured to hold the neutron absorber member thereon during insertion of the neutron absorber member into the control rod guide tube. The insertion tool rod is further configured to release the neutron absorber member when the neutron absorber member is fully installed in the control rod guide tube and the insertion tool rod is removed from the control rod guide tube.

In one example of the second aspect, the insertion tool rod comprises a spring on a bottom portion thereof. The spring is configured to hold the neutron absorber member on the insertion tool rod during insertion of the neutron absorber member into the control rod guide tube. The spring is further configured to release the neutron absorber member when the neutron absorber member is fully installed in the control rod guide tube and the insertion tool rod is removed from the control rod guide tube. In another example, the apparatus further comprises a neutron absorber member retainer through which the insertion tool rod extends, the retainer being configured to snap to a top nozzle of the spent fuel assembly above the control rod guide tube and retain the neutron absorber member in the control rod guide tube such that the insertion tool rod is forced to release the fully inserted neutron absorber member when the insertion tool rod is removed from the control rod guide tube, wherein the neutron absorber member is secured between the spring and the retainer until the retainer is snapped to the top nozzle of the spent fuel assembly and the insertion tool rod is removed from the control rod guide tube. In still another example, the retainer is configured to retain the fully inserted neutron absorber member within the control rod guide tube, thereby forcing the neutron absorber member to squeeze the spring inwardly when the insertion tool rod is removed from the control rod guide tube.

In another example of the second aspect, the apparatus further comprises a neutron absorber member retainer through which the insertion tool rod extends. The retainer is configured to snap to a top nozzle of the spent fuel assembly above the control rod guide tube and retain the neutron absorber member in the control rod guide tube such that the insertion tool rod is forced to release the fully inserted neutron absorber member when the insertion tool rod is removed from the control rod guide tube. In another example, the retainer comprises an aperture corresponding with the control rod guide tube. The aperture has a diameter that is less than a diameter of the neutron absorber member for the control rod guide tube and greater than a diameter of the insertion tool rod. In still another example, the insertion tool rod extends from the insertion tool base through the aperture of the retainer and an inner diameter of the neutron absorber member before the neutron absorber member is fully inserted into the control rod guide tube.

The second aspect may be provided alone or in combination with one or any combination of the examples of the second aspect discussed above.

In a third aspect of the disclosure, a neutron absorber member retainer for a top nozzle of a spent fuel assembly is provided. The top nozzle comprising a surface and a plurality of ledges above the surface. The surface comprises a first portion and a second portion. The first portion being through which a control rod guide tube of the spent fuel assembly is accessible and the second portion surrounds the first portion. The ledges extend inward from an outer surface of the top nozzle, each of the ledges comprising a bottom surface facing the second portion. The retainer comprises a plate configured to retain a neutron absorber member inserted in the control rod guide tube and a plurality of flanges configured to engage bottom surfaces of the ledges and position the plate adjacent to the surface of the top nozzle.

In one example of the third aspect, the plate comprises an aperture corresponding with the control rod guide tube, the aperture comprising a diameter that is less than a diameter of the neutron absorber member.

In another example of the third aspect, the retainer further comprises a plurality of guides configured to engage inward side surfaces of the ledges and guide the flanges into engagement with the bottom surfaces of the ledges. In one example, the flanges and the guides are positioned adjacent to outer corners of the plate. In another example, the flanges and the guides extend away from the control rod guide tube toward the ledges.

In still another example of the third aspect, the bottom surfaces of the ledges are predominantly horizontal. The flanges are curved from an upwardly angled portion thereof to engage the bottom surface of the ledge.

In yet another example of the third aspect, the flanges comprise engaging portions and extending portions. The engaging portions of the flanges are predominantly horizontal and engage the bottom surfaces of the ledges. The extending portions of the flanges extend from the engaging portions of the flanges over the first portion. Each of the extending portions of the flanges comprise a hole configured to allow a tool to disengage the engaging portions of the flanges from the bottom surfaces of the ledges.

The third example may be provided alone or in combination with one or any combination of the examples discussed herein.

Other features and aspects may be apparent from the following detailed description, the drawings, and the claims.

### BRIEF DESCRIPTION OF THE DRAWINGS

FIG. 1 is a perspective view illustrating an example of a fuel assembly.

FIG. 2 is a perspective view illustrating an example of an upper portion of the fuel assembly taken in area 2 of FIG. 1.

FIG. 3 is a perspective view illustrating an example of a neutron absorber member.

FIG. 4 is a cross-sectional view taken perpendicular to the elongated axis of the neutron absorber member of FIG. 3.

FIG. 5 is a perspective view illustrating an example of the fuel assembly taken in area 2 in FIG. 1 with neutron absorber members inserted into control rod guide tubes.

FIG. 6 is a close-up view illustrating an example of the fuel assembly of FIG. 5 with the neutron absorber members inserted into the control rod guide tubes.

FIG. 7 is a top view illustrating an example of the neutron absorber member inserted into the control rod guide tube.

FIG. 8 is a cut-away perspective view illustrating an example of a structure of the fuel assembly of FIG. 5 with neutron absorber members inserted into control rod guide tubes.

FIG. 9 is a perspective view illustrating an example of a neutron absorber member insertion apparatus.

FIG. 10 is a perspective view illustrating an example of an insertion tool rod.

FIG. 11 is a perspective view illustrating an example of an upper portion of the insertion tool rod of FIG. 10.

FIG. 12 is a perspective view illustrating an example of the upper portion of the insertion tool rod of FIG. 11 having a dowel pin installed in a hole of the insertion tool rod.

FIG. 13 is a perspective view illustrating an example of a bottom portion of the insertion tool rod of FIG. 10.

FIG. 14 is a perspective view illustrating an example of the bottom portion of the insertion tool rod of FIG. 13 having a neutron absorber member supported thereon.

FIG. 15 is a condensed, close-up perspective view illustrating an example of the neutron absorber member insertion apparatus of FIG. 9.

FIG. 16 is a perspective view illustrating an example of a top side of a cap plate of the neutron absorber member insertion apparatus of FIG. 15.

FIG. 17 is a perspective view illustrating an example of a bottom side of the cap plate of FIG. 16.

FIG. 18 is a perspective view illustrating an example of a top side of top plate of the neutron absorber member insertion apparatus of FIG. 15.

FIG. 19 is a sectional, see-through, perspective view illustrating an example of the top plate positioned on the standoff corners and standoff sides taken in area 15 of the neutron absorber member insertion apparatus of FIG. 15.

FIG. 20 is a side, see-through view illustrating and example of an upper portion of the neutron absorber member insertion apparatus of FIG. 15.

FIG. 21 is a perspective view illustrating an example of a neutron absorber member retainer.

FIG. 22 is a sectional view illustrating an example of the neutron absorber member insertion apparatus and the neutron absorber member retainer taken across 22-22 of FIG. 15.

FIG. 23 is a perspective view illustrating an example of the neutron absorber member insertion apparatus of FIG. 15 in alignment with a condensed illustration of the fuel assembly of FIG. 1.

FIG. 24 is a sectional view taken across 24-24 of FIG. 15 illustrating an example of neutron absorber members being inserted into control rod guide tubes of the fuel assembly of FIG. 23 using the neutron absorber member insertion apparatus of FIG. 15.

FIG. 25 is a sectional view taken across 24-24 of FIG. 15 illustrating an example of the neutron absorber members being further inserted into the control rod guide tubes of the fuel assembly of FIG. 24 using the neutron absorber member insertion apparatus of FIG. 24.

FIG. 26 is a sectional view taken across 24-24 of FIG. 15 illustrating an example of the neutron absorber members being fully inserted into the control rod guide tubes of the fuel assembly of FIG. 25 by the neutron absorber member insertion apparatus of FIG. 25.

FIG. 27 is a sectional view taken across 24-24 of FIG. 15 illustrating an example of insertion tool rods of the neutron absorber member insertion apparatus of FIG. 26 being removed from the neutron absorber member tubes that are fully inserted into the control rod guide tubes of the fuel assembly of FIG. 25.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

One or more examples are described and illustrated in the drawings. These illustrated examples are not intended to be limiting. For example, one or more aspects of an example may be utilized in other examples and even other types of devices.

Unless noted otherwise, the components described in the examples disclosed herein are composed of stainless steel. However, the examples disclosed herein are not limited thereto and can be composed of any materials or mixture of materials known to one of ordinary skill in the art to be used in nuclear fuel assembly applications.

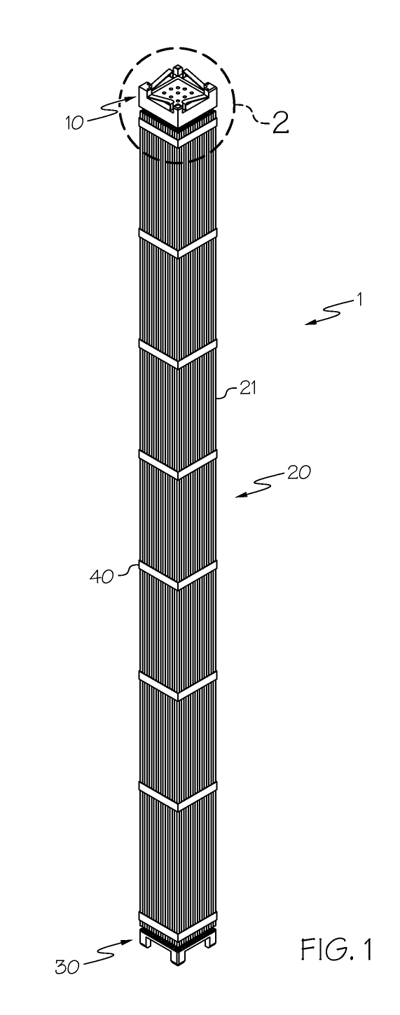

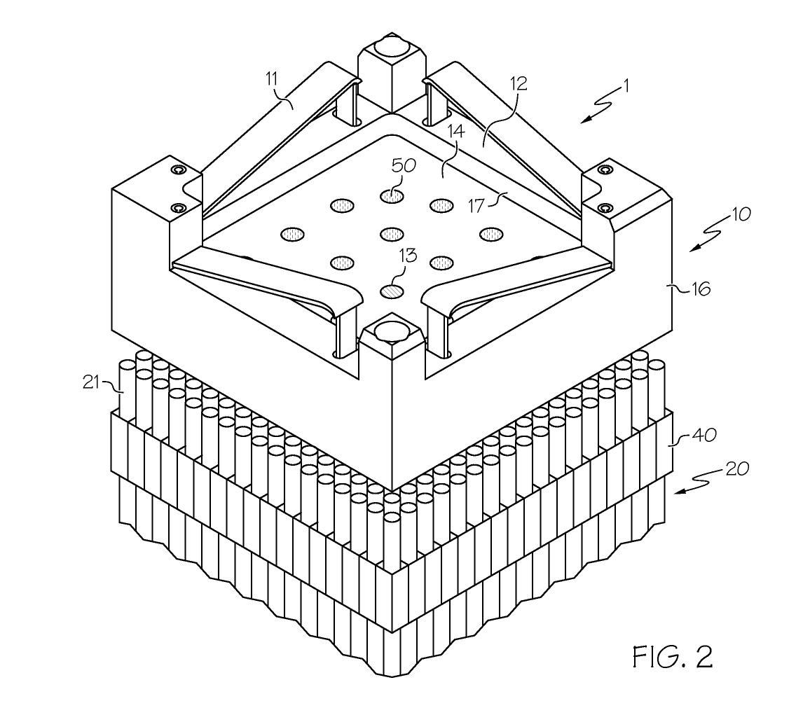

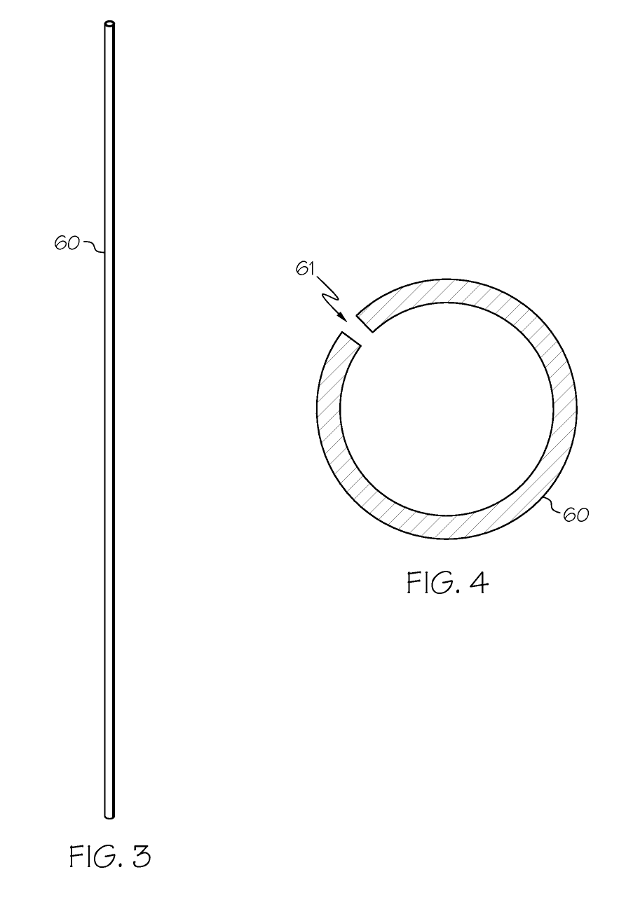

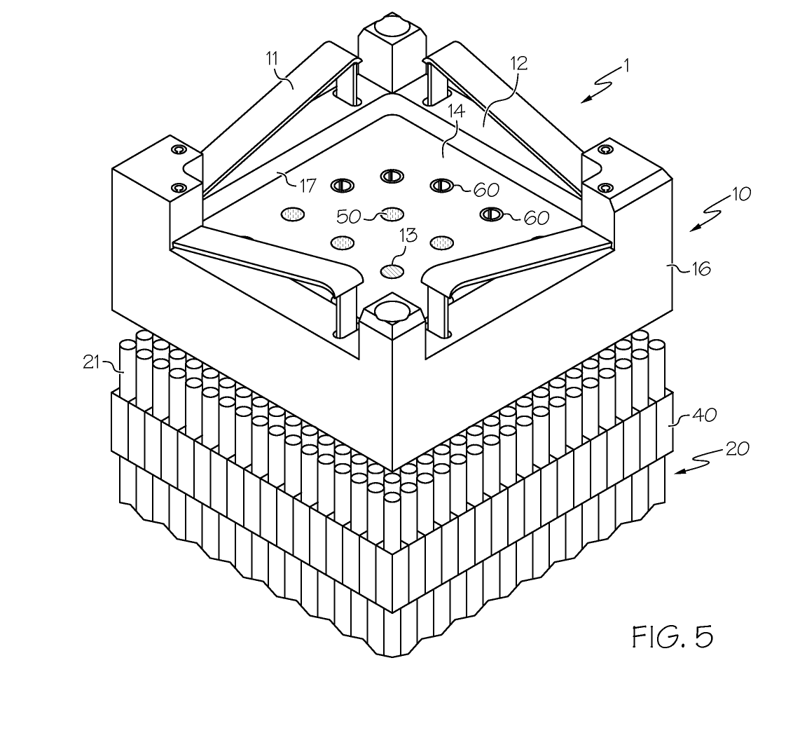

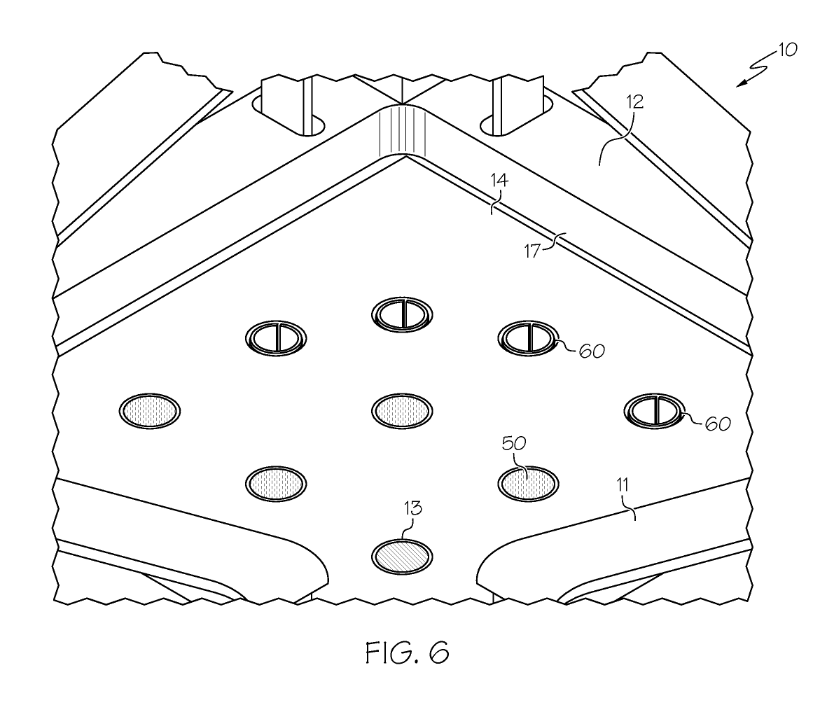

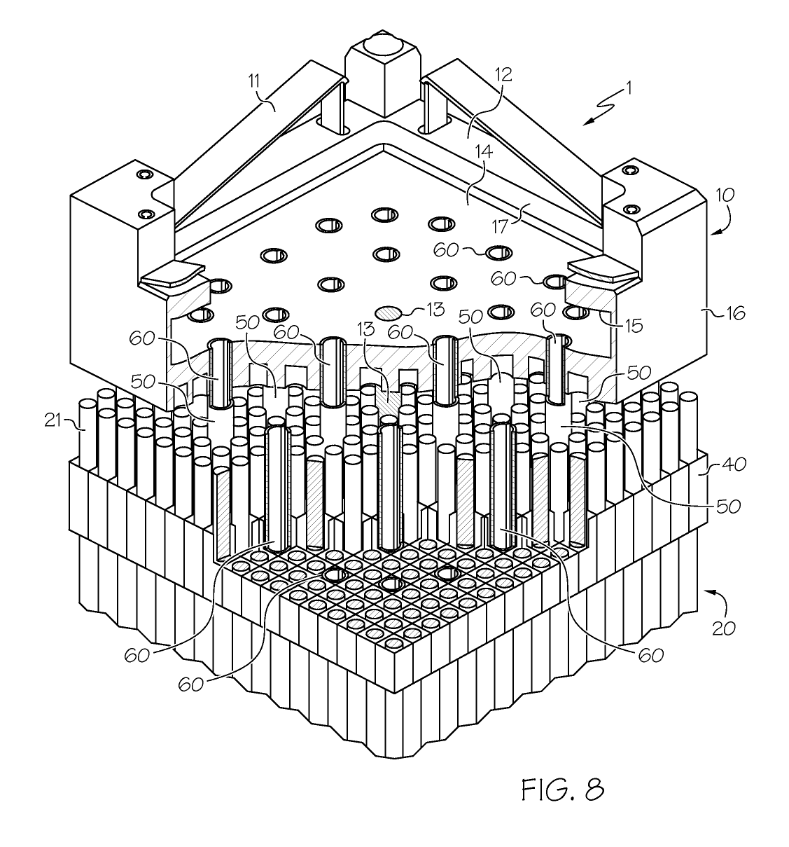

In examples illustrated in FIGS. 1-8, a spent fuel assembly 1 includes a top nozzle 10, a bundle 20 of fuel rods 21, and a bottom nozzle 30. The bundle 20 of fuel rods 21 extends between the top nozzle 10 and the bottom nozzle 30. The fuel rods 21 are secured to the bundle 20 by a plurality of grid guides 40 that laterally surround the bundle 20 at different points along a length of the bundle 20. A lateral shape of the top nozzle 10 and the bottom nozzle 30 may correspond to a lateral shape of the bundle 20 of fuel rods 21.

At least one control rod guide tube 50 and an instrumentation tube 13 are located within an interior portion of the bundle 20. In the examples described and illustrated herein, the instrumentation tube 13 is placed in a center of the bundle 20, and multiple control rod guide tubes 50 are placed in various positions within the bundle 20 surrounding the instrumentation tube 13. However, examples disclosed herein are not limited thereto, as the control rod guide tubes 50 and the instrumentation tube 13 may be placed at any location within the bundle 20 to maintain reactivity control of the fuel rods 21 during operation or subcriticality of the fuel assembly 1 when the fuel in the fuel rods 21 is spent. Further, an amount of control rod guide tubes 50 included within the bundle 20 may vary in accordance such that control of the fuel rods 21 during operation or subcriticality of the fuel assembly 1 when the fuel in the fuel rods 21 is spent is maintained.

The control rod guide tubes 50 and the instrumentation tube 13 are accessible at the top nozzle 10 through a surface 14 and within a predominately square periphery of the surface 14 surrounding a portion of the surface 14 at which the control rod guide tubes 50 and the instrumentation tube 13 are accessible. The predominately square periphery corresponds with a plurality of ledges 12 positioned above the surface 14. The ledges 12 extend inward from an outer surface of the top nozzle 10 and include bottom surfaces 15 oriented horizontally over portions of the surface 14 at which there is no access to the control rod guide tubes 50 or the instrumentation tube 13. Outer portions 16 of the ledges 12 define an outer shape of the top nozzle 10. A plurality of hold down springs 11 may be positioned on, and configured to collapse within, the ledges 12 to position the fuel assembly 1 in relation to other elements of a reactor (not shown) during reactor operation.

During operation of the reactor in which the fuel assembly 1 is used, a flux-probing monitor (not shown) may be inserted into the instrumentation tube 13 to map local neutron flux. Further, control rods (not shown) may be inserted into the control rod guide tubes 50 to control neutron flux of the fuel assembly 1 during operation of the reactor. In the examples described herein, the fuel assembly 1 is described as being a pressurized water reactor (PWR). However, embodiments disclosed herein are not limited thereto.

After the fuel assembly 1 is spent and moved into a storage pool (not shown), neutron absorber members 60 can be inserted into the control rod guide tubes 50 to absorb neutrons emanating from the fuel rods 21 of the bundle 20, thereby maintaining subcriticality of the fuel assembly 1 within the storage pool. Each of the neutron absorber members 60 may have a length that is about 0.5% less than a length of an inner portion of a control rod guide tube 50. Each of the neutron absorber members 60 may extend substantially throughout a length of the corresponding control rod guide tube 50 and have an effective length that continuously extends substantially throughout the length of the active fuel region of the fuel assembly 1. For example, each of the neutron absorber members 60 may include multiple sections (not shown) having a combined length that is substantially equivalent to the length of the corresponding control rod guide tube 50. Each of the neutron absorber members 60 may additionally have an outer diameter that enables the neutron absorber member 60 to fit within an inner diameter of the inner portion of the control rode guide tube 50.

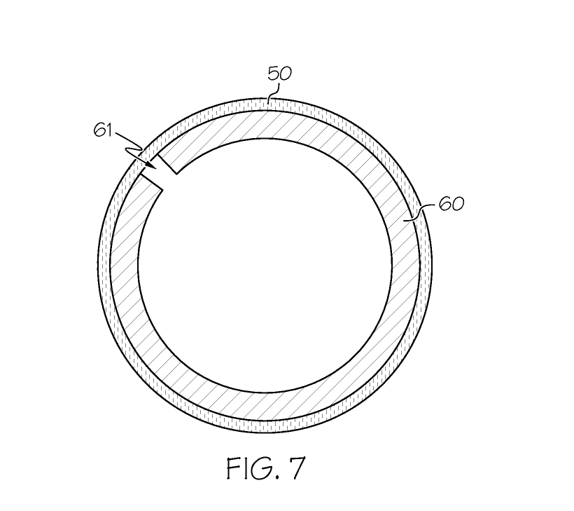

In the examples described and illustrated herein, each of the neutron absorber members 60 is a tube having a split 61 throughout a length of the neutron absorber member 60. The split 61 may cause the neutron absorber member 60 to substantially have a C-shape in the neutron absorber members 60 when viewing the neutron absorber members 61 from above, such as in the examples illustrated in FIGS. 4 and 7. A width of a split 61 of an installed neutron absorber member 60 may vary throughout the length of the neutron absorber member 60 according to a shape of the respective control rod guide tube 50.

In this example, each of the neutron absorber members 60 is formed substantially of an aluminum-B₄C metal matrix composite or composed of a metal matrix including boron carbide, in which the amount of boron carbide corresponds with a reactivity control provided to the spent fuel assembly 1 by the corresponding neutron absorber member 60. However, examples described herein are not limited thereto. For example, the neutron absorber member 60 may be formed substantially of solid rod of aluminum boron-carbide or any other materials or combination of materials known to one having ordinary skill in the art that are able to be extruded or formed to tolerances that are provided by aluminum-B₄C metal matrix composite.

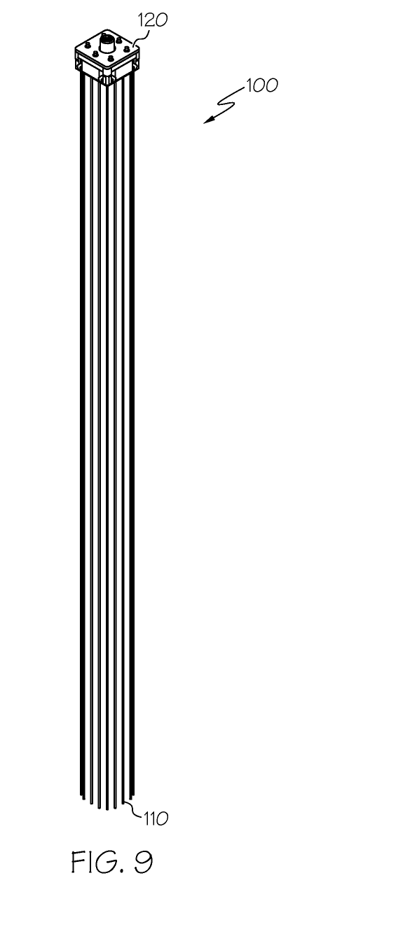

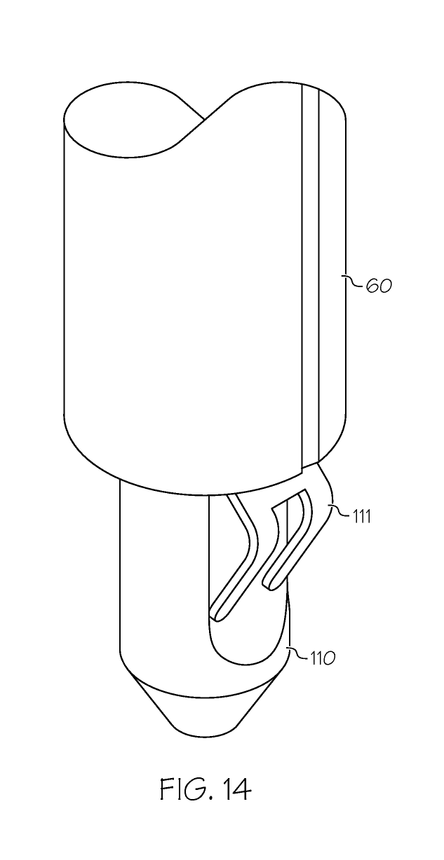

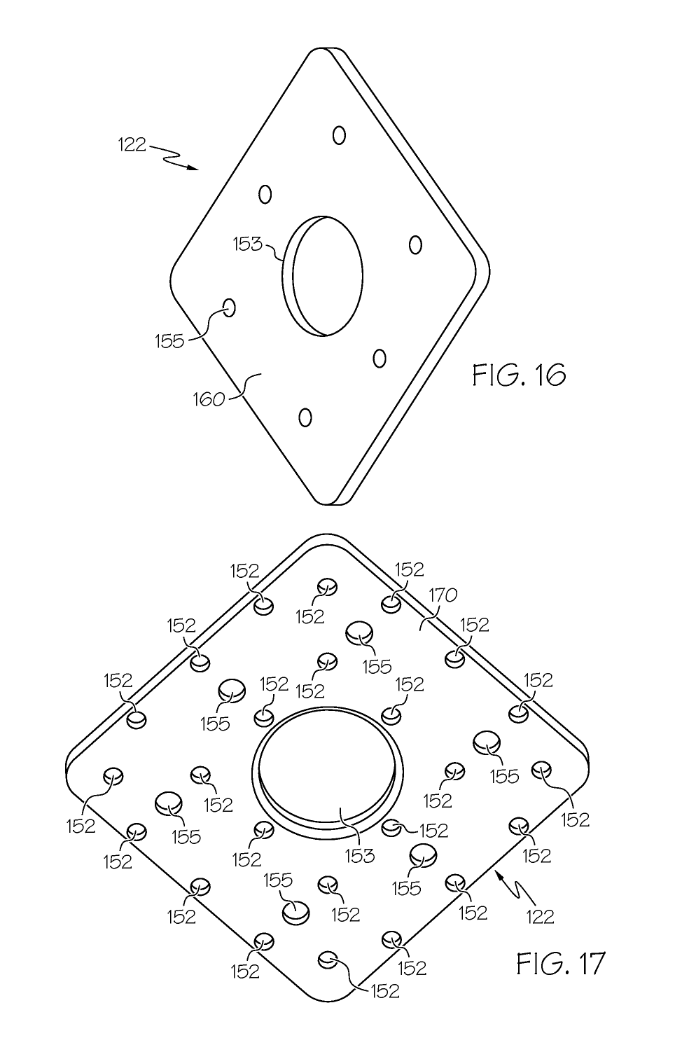

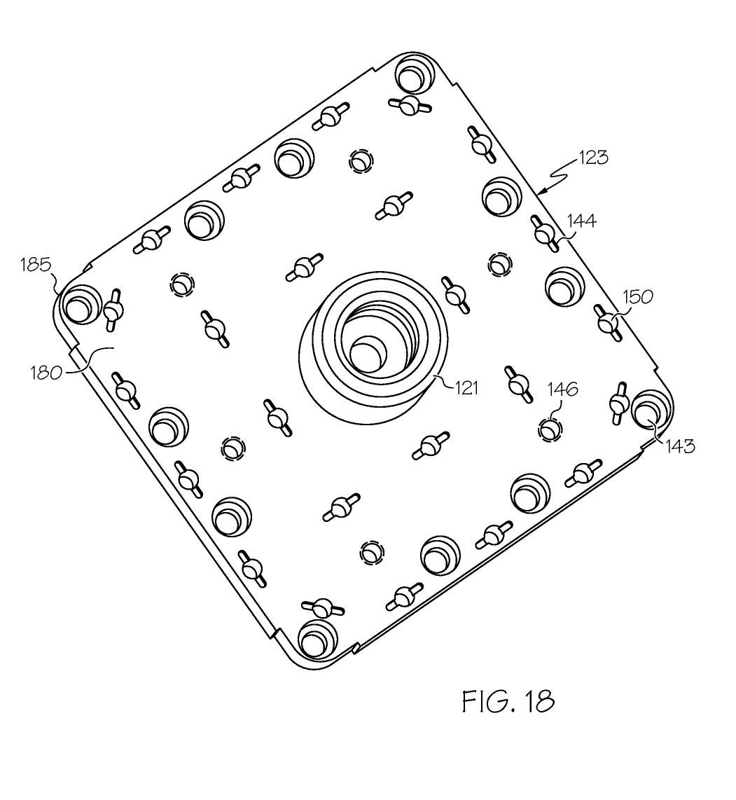

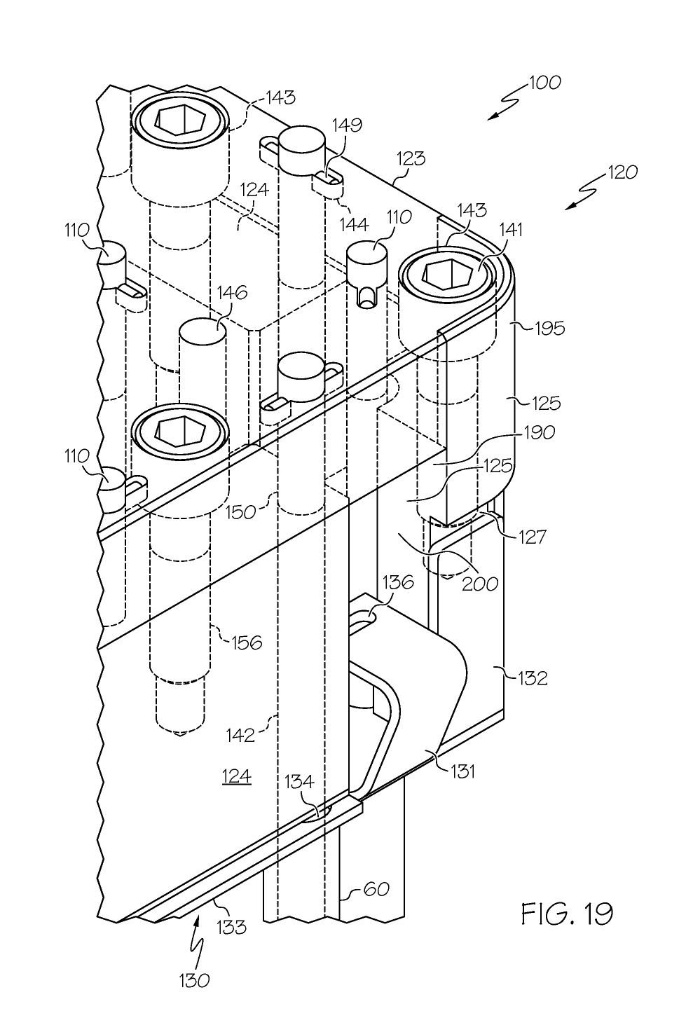

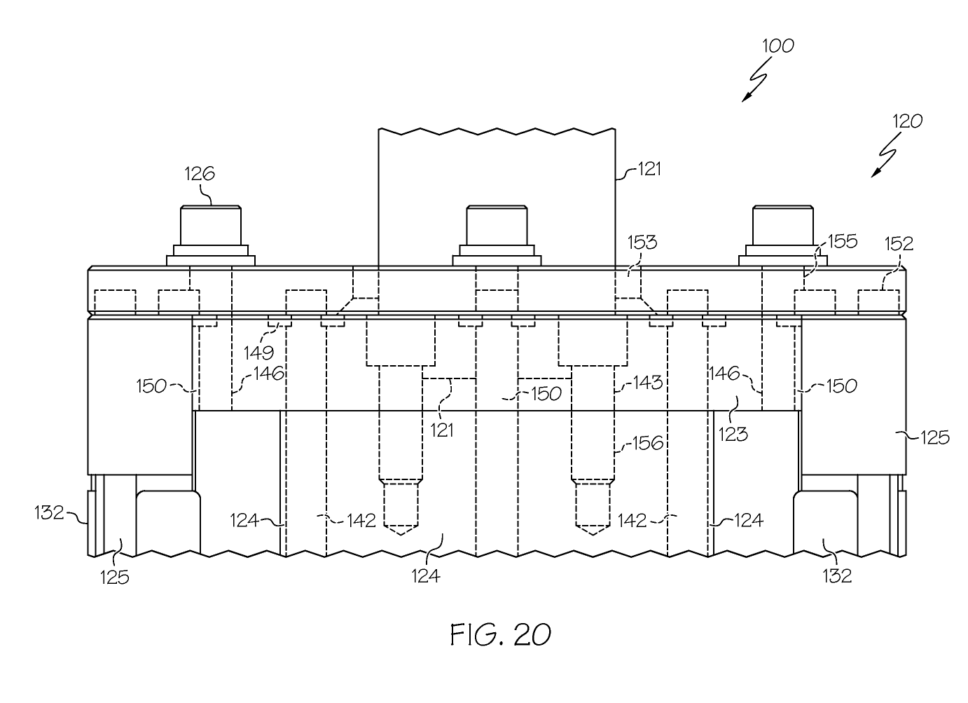

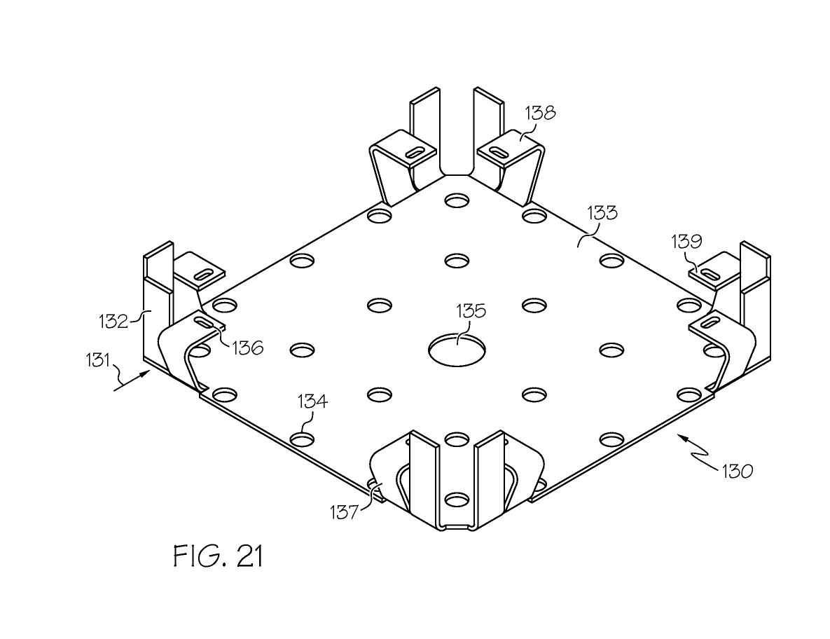

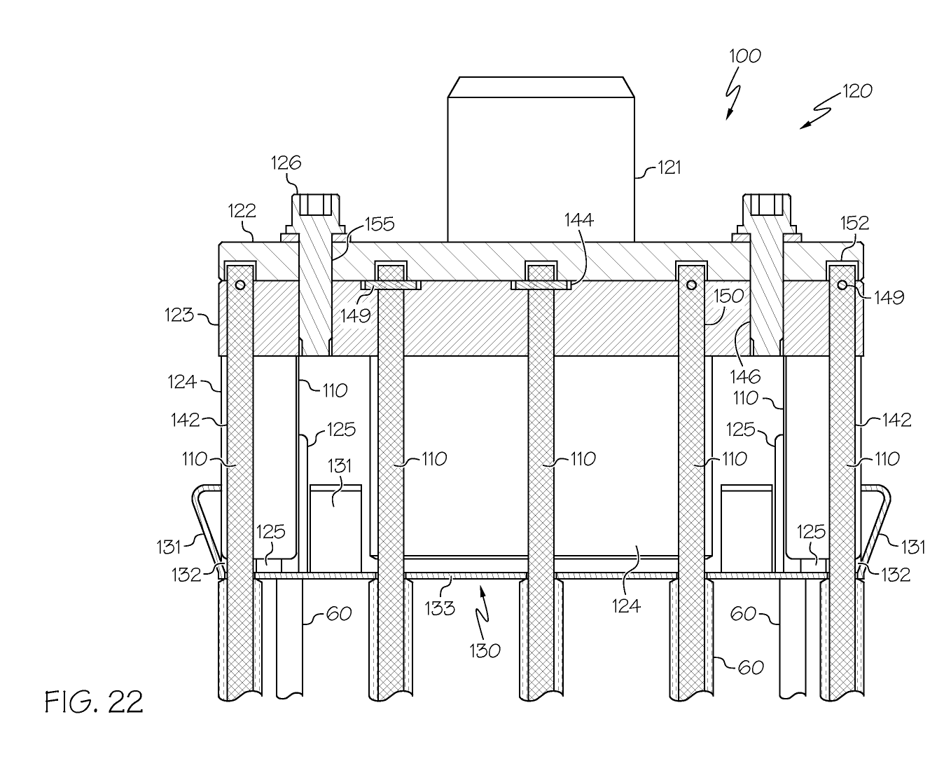

In examples illustrated in FIGS. 9-22, a neutron absorber member insertion apparatus 100 includes an insertion tool base 120 and insertion tool rods 110. The insertion tool base 120 includes a cap plate 122, a top plate 123, standoff sides 124, and standoff corners 125. The cap plate 122 is connected to the top plate 123 and contacts the top plate 123 and the standoff corners 125. The top plate 123 is connected to and contacts the cap plate 123, the standoff sides 124, and the standoff corners 125.

The insertion tool base 120 is configured to secure multiple insertion tool rods 110 therein to extend from the insertion tool base 120. The cap plate 122, the top plate 123, the standoff sides 124, and the standoff corners 125 include various bores and insets with which the insertion tool rods 110 are configured to interact such that the insertion tool rods 110 are secured by the insertion tool base 120 while extending from the insertion tool base 120. Examples of these bores and insets include rod clearance relief 152 inset in a bottom side 170 of the cap plate 122, top rod bores 150 positioned through the top plate 123, and standoff side rod bores 142 positioned through the standoff sides 124.

The insertion tool rods 110 are removably secured within and extending from the insertion tool base 120 according to a position of the control rod guide tubes 50 into which the corresponding neutron absorber members 60 are to be inserted. The insertion tool rods 110 are set by and extend through the various bores and insets of the insertion apparatus 100 mentioned above. The insertion tool rods 110 are placed strategically into the insertion apparatus 100 to correspond with the control rod guide tubes 50 in which the neutron absorber members 60 will be inserted. Each of the neutron absorber members 60 may be configured to at least partially surround an insertion tool rod 110. Each insertion tool rod 110 is configured to hold a neutron absorber member 60 partially surrounding the insertion tool rod 110 thereon until full insertion of the neutron absorber member 60 into a corresponding control rod guide tube 50 is achieved.

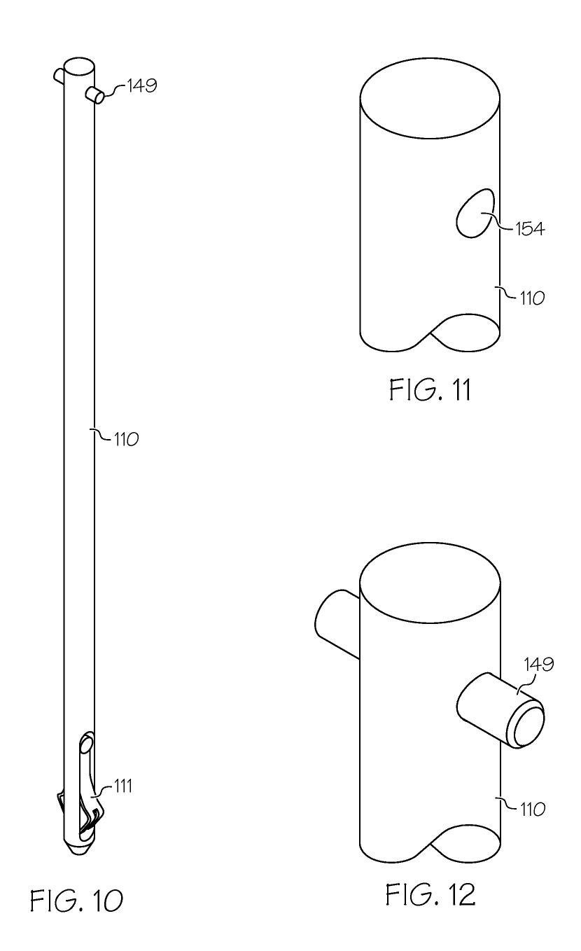

An example structure of an insertion tool rod 110 is illustrated in FIGS. 10-14. A dowel pin bore 154 is positioned through the insertion tool rod 110 at an upper portion thereof. The dowel pin bore 154 is configured to accommodate a dowel pin 149 extending there through. The dowel pin 149 is configured to interact with a dowel pin inset 144 positioned in a top surface 180 of the top plate 123 that extends from opposite sides of a top rod bore 150. The insertion tool rod 110 can be inserted through the top rod bore 150 of the top plate 123 at the top surface 180. Upon full insertion into the top rod bore 150, the dowel pin 149 is configured to rest within the dowel pin inset 144, thereby substantially inhibiting any likelihood of the insertion tool rod 110 slipping through the top rod bore 150 or being removed from the insertion apparatus 100 through down force. Further, the resting of the dowel pin 149 within the dowel pin inset 144 substantially inhibits an ability of the insertion tool rod 110 to axially rotate when the bottom side 170 of the cap plate 122 is place on the top surface 180 of the top plate 123, as the bottom side 170 of the cap plate 122 covers the dowel pin inset 144 and the dowel pin 149 positioned within the dowel pin insert 144.

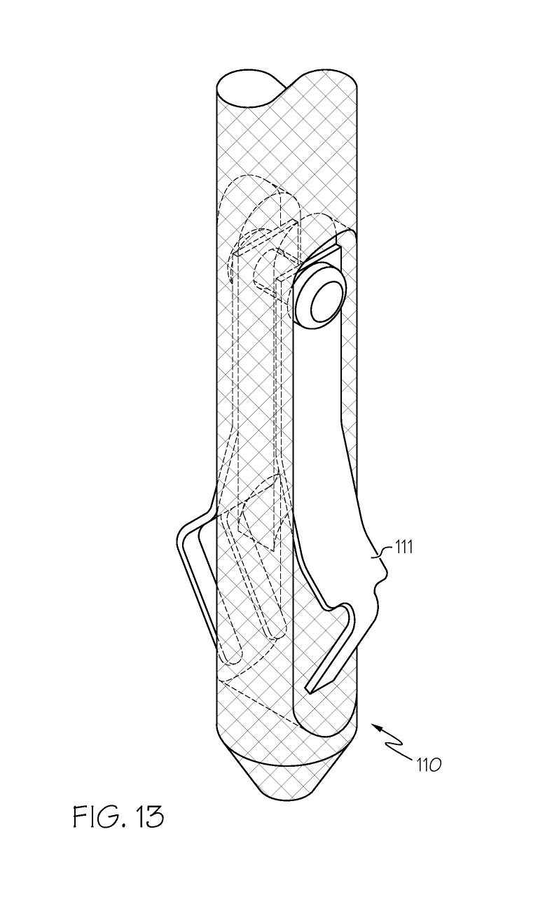

Each of the insertion tool rods 110 additionally includes a spring 111 positioned at a lower portion thereof. The spring 111 is biased outward from a center of the insertion tool rod 110 and has a portion that protrudes outward from the insertion tool rod 110. The spring 111 is configured to inhibit removal of a neutron absorber member 60 placed there above and over, thereby serving to hold the neutron absorber member 60 on the insertion tool rod 110 until full insertion of the neutron absorber member 60 into the corresponding control rod guide tube 50 is achieved. In the examples illustrated in FIGS. 10 and 13, the insertion tool rod 110 includes two springs 111 on opposing sides of the insertion tool rod 110. However, the insertion tool rod 110 disclosed herein is not limited thereto. For example, an insertion tool rod 110 may include any number of springs 111 positioned at any particular orientation that would inhibit removal of items placed above the springs 111 or mechanically actuated mechanism for positive retention during the insertion process.

The neutron absorber member 60 can be inserted on the insertion tool rod 110 from the bottom of the insertion tool rod 110. In order for the neutron absorber member 60 to be inserted onto the insertion tool rod 110, the spring 111 is squeezed inwardly against its natural bias, thereby allowing the neutron absorber member 60 to be inserted over and above the spring 111 and onto the insertion tool rod 110. After a bottom end of the neutron absorber member 60 is positioned above the protruding portion of the spring 111, the spring 111 returns to its naturally biased state. As a result, the protruding portion of the spring 111 holds the neutron absorber member 60 there above at least partially surrounding the insertion tool rod 110 and inhibits the neutron absorber member 60 from being removed from at least partially surrounding the insertion tool rod 110 until the full insertion of the neutron absorber member 60 within the corresponding control rod guide tube 50 is achieved.

The cap plate 122 constitutes a top surface 160 of the insertion tool base 120. The top plate 123 is positioned underneath the cap plate 122 and has a top surface 180 configured to be in contact with a bottom surface 170 of the cap plate 122. The cap plate 122 includes cap plate bolt bores 155 through which cap bolts 126 are configured to extend into top plate bolt bores 146 of the top plate 123 and secure the top plate 123 to the cap plate 122. The cap plate 122 additionally includes a handling bore 153 through which a handling interface 121 positioned on the top surface 180 of the top plate 123 extends for mating with a handling tool (not shown). When mated to the handling interface 121, the handling tool can allow an operator to manipulate the insertion apparatus 100 in order to fully insert the neutron absorber members 60 into the control rod guide tubes 50. The cap plate 122 further includes rod clearance relief 152 that is inset into the bottom side 170 of the cap plate 122. The rod clearance relief 152 accommodates a top portion of the insertion tool rod 110 extending above the top plate 123 and an upper surface of the dowel pins 149.

When the cap plate 122 is fitted onto the top plate 123, the handling interface 121 of the top plate 123 extends through the handling bore 153 of the cap plate 122 Additionally, the insertion tool rods 110 are inserted through the top rod bores 150 of the top plate 123 such that the dowel pins 149 of the insertion tool rods 110 rest in the dowel pin insets 144 of the top plate 123. As a result of the dowel pins 149 being supported by the dowel pin insets 144 of the top plate 123, the top portions of the insertion tool rods 110 that are held above the top plate 123 fit inside the rod clearance relief 152 of the cap plate 122. The cap bolts 126 are secured within the cap plate bolt bores 155 and the top plate bolt bores 146, thereby securing the top plate 123 to the cap plate 122. The securing of the top plate 123 to the cap plate 122 subsequently secures the top portions of the insertion tool rods 110 extending above the top plate 123 within the rod clearance relief 152 of the cap plate 122. The cap plate 122 secures the dowel pin 149 that engages the insertion tool rods 110 inhibiting an impact of any upward forces placed on the insertion tool rods 110, thereby inhibiting an impact of any upward forces placed on the insertion tool rods 110. As a result, when the cap plate 122 and the top plate 123 are secured to each other, the insertion tool rods 110 are substantially inhibited from movement throughout a length thereof.

The top plate 123 additionally includes side bores 143 positioned on outer edges thereof. The side bores 143 are configured to accommodate side bolts 141 extending there through. The side bolts 141 extending through the side bores 143 positioned in the corners 185 of the top plate 123 extend through the side bores 143 and into standoff corners 125 respectively positioned underneath and outside of the corners 185 of the top plate 123. An outer surface of each of the corners 185 of the top plate 123 is slightly trimmed and contoured around the corner 185 in comparison with the outer surfaces of other areas of the top plate 123. This enables an upper portion 195 of each of the standoff corners 125 to substantially surround the outer surface of the corner 185 of the top plate 123. A lower portion 200 of each of the standoff corners 125 includes a standoff corner inset 190 through which a side bolt 141 is inserted after the side bolt 141 extends through the side bore 143 in the corner 185 of the top plate 123. The top plate 123 is connected to the standoff corners 125 by the side bolts 141 extending through the side bores 143 positioned in the corners 185 of the top plate 123 and the standoff corner insets 190 of the standoff corners 125 such that the standoff corners 125 are secured to and contacting the top plate 123.

The other side bores 143 are positioned on outer edges of the top plate 123 between the corners 185 of the top plate 123. The side bolts 141 extend through these side bores 143 and into standoff side insets 156 positioned within standoff sides 124. The top plate 123 is connected to the standoff sides 124 by the side bolts 141 extending through the side bores 143 positioned between the corners 185 of the top plate 123 and into the standoff side insets 156 such that the standoff sides 124 are secured to and contacting the top plate 123. The standoff sides 124 additionally include standoff side rod bores 142 positioned there through. The standoff side rod bores 142 accommodate insertion tool rods 110 positioned along the outer sides of the top plate 123 between the side bolts 141.

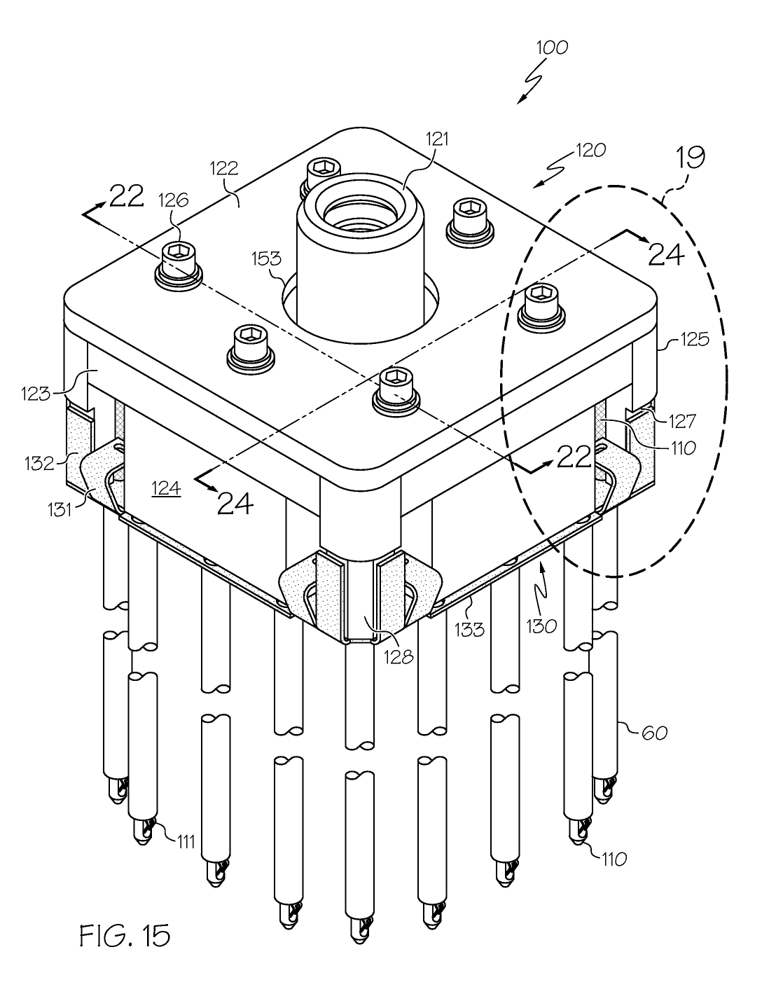

In examples illustrated in FIGS. 15 and 19-27, the insertion tool rods 110 extend through a neutron absorber member retainer 130. The retainer 130 includes retainer snaps 131 on outer edges thereof, which are configured to snap to the top nozzle 10 of the fuel assembly 1 above the control rod guide tubes 50. The retainer 130 is configured to retain neutron absorber members 60 in the corresponding control rod guide tubes 50 such that the insertion tool rods 110 are forced to release the neutron absorber members 60 when fully inserted in the control rod guides tubes 50 when the insertion tool rods 110 are being removed from the control rod guide tubes 50. The neutron absorber members 60 are secured between the springs 111 of the insertion tool rods 110 and the retainer 130 until the retainer 130 is snapped to the spent fuel assembly 1 and the insertion tool rods 110 are removed from the control rod guide tubes 50.

The retainer 130 is configured to retain the fully inserted neutron absorber members 60 within the control rod guide tubes 50. As a result, the neutron absorber members 60 are forced to squeeze the springs 111 inwardly when the insertion tool rods 110 are removed from the control rod guide tubes 50.

In an example, the retainer 130 includes retainer guides 132 at outer corners thereof. The retainer guides 132 are configured to engage inward side surfaces 17 of the ledges 12. The retainer 130 additionally includes a plate 133, which is configured to retain the neutron absorber members 60 inserted in the corresponding control rod guide tubes 50. Retainer bores 134 of the retainer 130 correspond with the control rod guide tubes 50 and are sized to retain the neutron absorber members 60 inserted in the corresponding control rod guide tubes 50. An instrumentation bore access port 135 of the retainer 130 is positioned through the plate 133.

The retainer snaps 131 illustrated herein are configured to engage bottom surfaces 15 of the ledges 12 and position the plate 133 adjacent to or contacting the surface 14 of the top nozzle 10. The retainer guides 132 of the retainer 130 extend upward from the plate 133. The retainer guides 132 and snaps 131 may be positioned adjacent to outer corners of the plate 133 and extending away from the control rod guide tubes 50 toward the ledges 12. In an example, the bottom surfaces 15 of the ledges 12 may be horizontal. In such an example, the snaps 131 may be curved from upwardly angled portions 137 of the snaps 131 to engage the bottom surfaces 15 of the ledges 12.

The curve separates the upwardly angled portions 137 of the snaps 131 from extending portions 139 and engaging portions 138 of the snaps 131. The engaging portions 138 illustrated herein are predominately horizontal and engage the bottom surfaces 15 of the ledges 12 when inserted under the ledges 12. The extending portions 139 illustrated herein extend from the engaging portions 138 of the snaps 131 over the portion of the surface 14 at which the control rod guide tubes 50 and the instrumentation tube 13 are accessible. Each of the extending portions 139 include a hole 136 configured to allow a tool (not shown) to disengage the engaging portion 138 of the snaps 131 from the bottom surfaces 15 of the ledges 12. Once the retainer snaps 131 illustrated herein engage the bottom surfaces 15 of the ledges 12, the retainer 130 is locked into place. The retainer bores 134 include a diameter that is less than a diameter of the neutron absorber members 60 to inhibit the neutron absorber members 60 from leaving or being removed from the control rod guide tubes 50.

FIG. 15 illustrates an example of the retainer 130 interacting with the insertion tool base 120 before insertion of the neutron absorber members 60 into the control rod guide tubes 50. In this example, loads of the neutron absorber members 60 are placed upon the springs 111 of the insertion tool rods 110. The springs 111 inhibit the neutron absorber members 60 from falling from around the portions of the insertion tool rods 110 positioned above the springs 111. The insertion tool rods 110 extend through the retainer bores 134 from a point emanating from the cap plate 122.

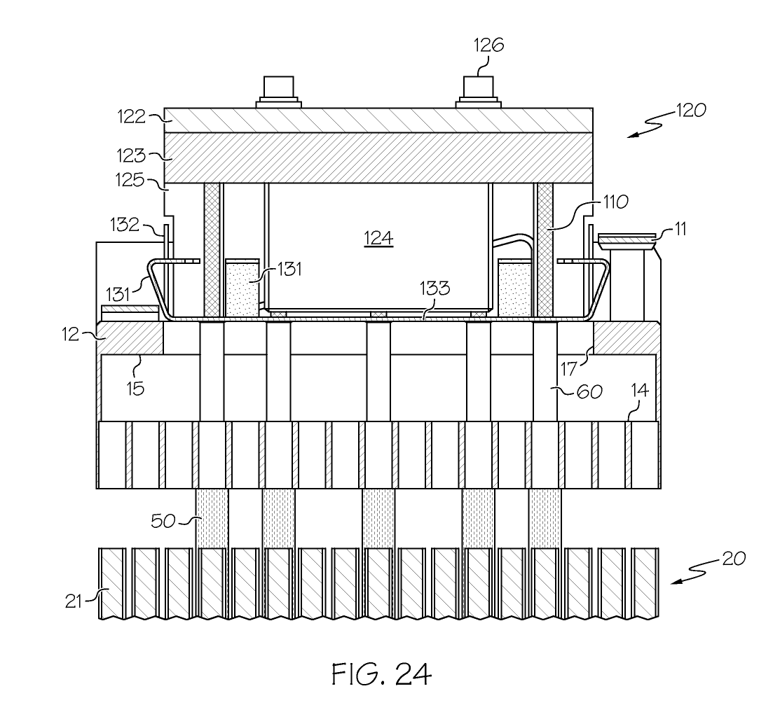

As is additionally illustrated in FIGS. 24-27, prior to full insertion of the neutron absorber members 60 into the control rod guide tubes 50, the insertion tool rods 110 are sized such that the neutron absorber members 60 extend around the insertion tool rods 110 substantially from the springs 111 to the plate 133. As such, the neutron absorber members 60 are supported by the springs 111 of the insertion tool rods 110. Furthermore, the supported neutron absorber members 60 subsequently support the retainer 130.

The retainer 130 is supported by the neutron absorber members 60 such that the guides 132 are positioned adjacent to or contacting outer inset surfaces 127 of the standoff corners 125, which are positioned adjacent a rounded corner 128 of the standoff corners 125. Further, the snaps 131 are positioned between the standoff corners 125 and the standoff sides 124 and underneath the top plate 123. The upwardly angled portions 137 of the snaps 131 extend outward from the outer edges of the plate 133 of the retainer 130 until the snaps 131 curve into the engaging portions 138 of the snaps 131. The engaging portions 138, as well as the extending portions 139, are substantially horizontal and substantially parallel with the top plate 123 and the plate 133 of the retainer 130. The engaging portions 138 extend from a point outside peripheries of the insertion tool 120 and the retainer 130 to a point surrounded by the plate 133, a standoff side 124, a standoff corner 125, and the top plate 123.

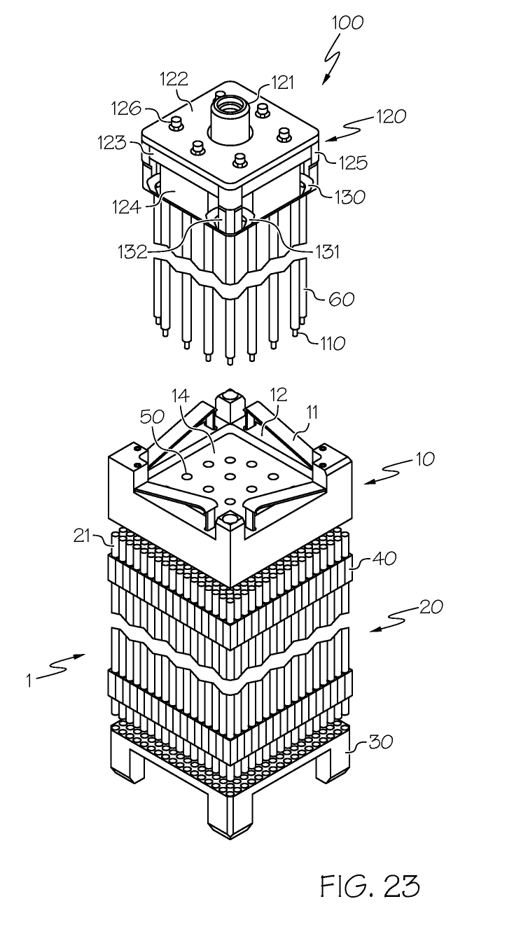

FIG. 23 illustrates the insertion apparatus 100 aligned for insertion of the neutron absorber members 60 into corresponding control rod guide tubes 50 of the fuel assembly 1. While the fuel assembly 1 has a certain example arrangement of the control rod guide tubes 50 and the insertion apparatus 100 illustrated herein is configured to provide insertion tool rods 110 in such an arrangement as to correspond to the arrangement of the control rod guide tubes 50, embodiments herein are not limited thereto. For example, the control rod guide tubes 50 can be arranged in any way necessary as recognized by one having ordinary skill in the art to provide control during operation of the fuel assembly 1. Similarly, the insertion tool 120 can be configured in such a way as to accommodate an arrangement of the control rod guide tubes 50.

FIGS. 24-27 illustrate an example process by which the neutron absorber members 60 may be inserted into the control rod guide tubes 50 using the insertion apparatus 100. In FIG. 24, the neutron absorber members 60 are in the process of being inserted into the control rod guide tubes 50. The retainer 130 is being supported by the neutron absorber members 60 and is positioned just above the inward side surfaces 17 of the ledges 12.

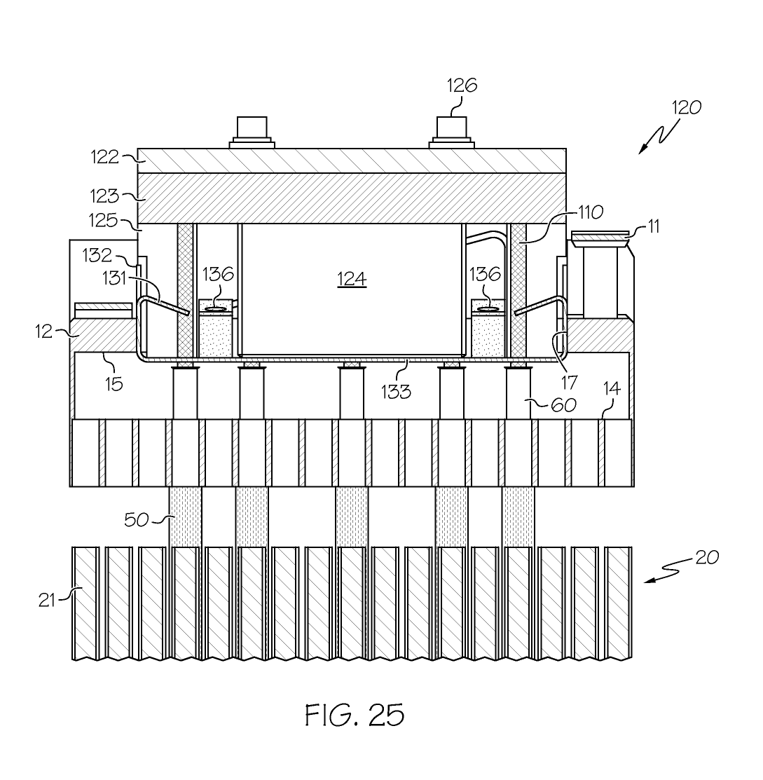

In FIG. 25, the insertion tool 120 has been pushed further toward the surface 14 of the top nozzle 10. The retainer 130 has been pushed between the inward side surfaces 17 of the ledges 12. The snaps 131, which are biased outwardly from the plate 133 area of the retainer 130, are pinched inward by the inward side surfaces 17 of the ledges 12. The guides 132 of the retainer 130 promote proper alignment of the insertion tool 120 with the top nozzle 10.

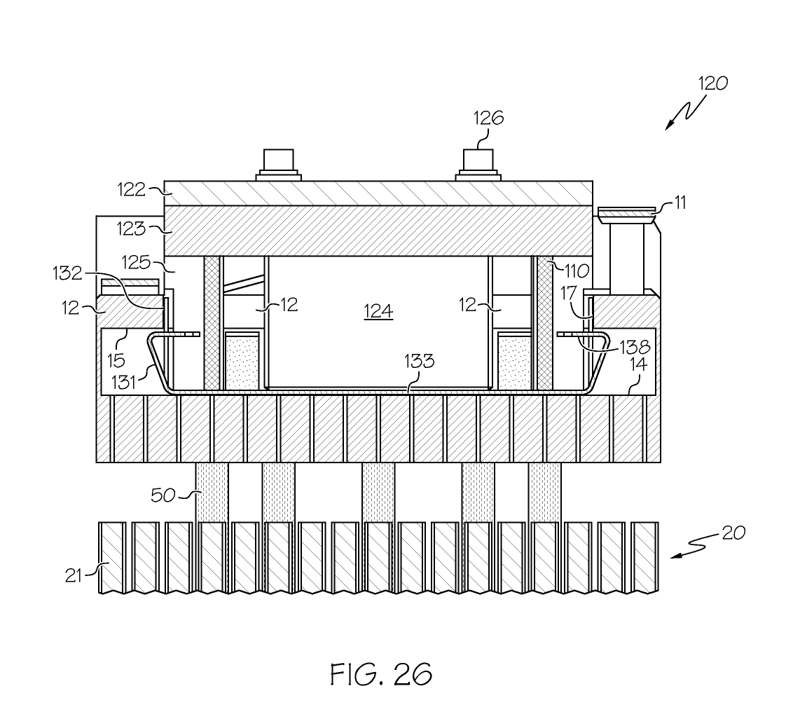

In FIG. 26, the insertion tool 120 has been pushed to a point at which the neutron absorber members 60 are fully inserted into the control rod guide tubes 50. In this position, the snaps 131 of the retainer 130 have passed through the inward side surfaces 17 of the ledges 12 and extended outwardly according to their bias. As a result, engaging portions 138 of the snaps 131 are now underneath and engaged with the bottom surfaces 15 of the ledges 12, thereby inhibiting removal of the retainer 130 from the top nozzle 10 of the fuel assembly 1.

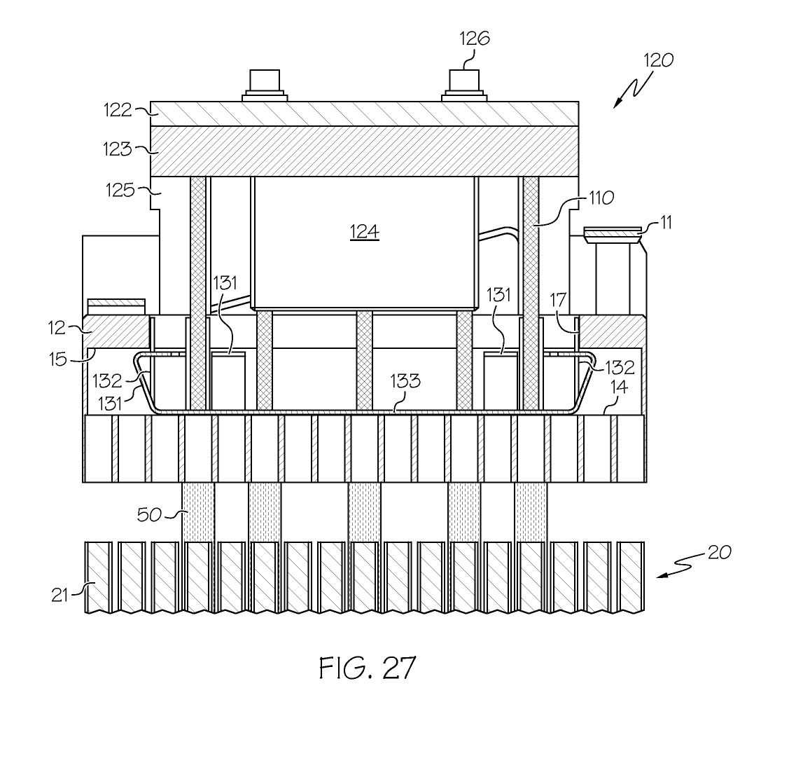

In FIG. 27, the insertion tool 120 is in the process of being pulled away from the fuel assembly 1. The retainer 130 is in place within the top nozzle 10 of the fuel assembly 1, thereby inhibiting the neutron absorber members 60 from being removed from the control rod guide tubes 50. Because the neutron absorber members 60 are inhibited from removal from the control rod guide tubes 50, the downward force being placed on the springs (not shown) at the lower portions of the insertion tool rods 110 by the neutron absorber members 60 serves to push the springs inward, thereby allowing the insertion tool rods 110 to be removed from within the neutron absorber members 60. When the insertion tool rods 110 are fully removed from the neutron absorber members 60, the springs will be free to expand toward their outward bias.

While the neutron absorber member retainer 130 is illustrated herein as inhibiting tubular neutron absorber members 60 comprising a tube split throughout a length of the tube from being removed from the control rod guide tubes 50, embodiments described herein are not limited thereto. For example, the neutron absorber member retainer 130 may inhibit the removal of neutron absorber members having various alternative shapes and constitutions.

A number of examples have been described above. Nevertheless, it will be understood that various modifications may be made. For example, suitable results may be achieved if the described elements are combined in a different manner and/or replaced or supplemented by other elements or their equivalents. Accordingly, other implementations are within the scope of the following claims.

What is claimed is:

1. A neutron absorber member for a control rod guide tube of a spent fuel assembly, the absorber member being a tube split throughout a length thereof.

2. The absorber member of claim 1, wherein the absorber member is composed of a metal matrix composite comprising boron carbide.

3. The absorber member of claim 2, wherein an amount of the boron carbide in the metal matrix corresponds with a reactivity control provided to the spent fuel assembly by the absorber member.

4. The absorber member of claim 1, wherein a width of the split varies throughout the length of the absorber member according to a shape of the control rod guide tube.

5. The absorber member of claim 1, wherein the absorber member comprises a C-shape formed by the split.

6. The absorber member of claim 1, wherein the absorber member extends substantially throughout a length of the control rod guide tube.

7. The absorber member of claim 6, wherein the absorber member comprises a plurality of sections having a combined length that is substantially equivalent to the length of the control rod guide tube.

8. An insertion apparatus for inserting the neutron absorber member of claim 1 into the control rod guide tube of the spent fuel assembly, the apparatus comprising:
an insertion tool base; and
an insertion tool rod removably secured within and extending from the insertion tool base according to a position of the control rod guide tube into which the neutron absorber member is to be inserted, the insertion tool rod being configured to hold the neutron absorber member thereon during insertion of the neutron absorber member into the control rod guide tube and release the neutron absorber member when the neutron absorber member is fully installed in the control rod guide tube and the insertion tool rod is removed from the control rod guide tube.

9. An insertion apparatus for inserting a neutron absorber member into a control rod guide tube of a spent fuel assembly, the apparatus comprising:
an insertion tool base; and
an insertion tool rod removably secured within and extending from the insertion tool base according to a position of the control rod guide tube into which the neutron absorber member is to be inserted, the insertion tool rod being configured to hold the neutron absorber member thereon during insertion of the neutron absorber member into the control rod guide tube and release the neutron absorber member when the neutron absorber member is fully installed in the control rod guide tube and the insertion tool rod is removed from the control rod guide tube.

10. The apparatus of claim 9, wherein the insertion tool rod comprises a spring on a bottom portion thereof, the spring being configured to hold the neutron absorber member on the insertion tool rod during insertion of the neutron absorber member into the control rod guide tube and release the neutron absorber member when the neutron absorber member is fully installed in the control rod guide tube and the insertion tool rod is removed from the control rod guide tube.

11. The apparatus of claim 10, further comprising:
a neutron absorber member retainer through which the insertion tool rod extends, the retainer being configured to snap to a top nozzle of the spent fuel assembly above the control rod guide tube and retain the neutron absorber member in the control rod guide tube such that the insertion tool rod is forced to release the fully inserted neutron absorber member when the insertion tool rod is removed from the control rod guide tube,
wherein the neutron absorber member is secured between the spring and the retainer until the retainer is snapped to the top nozzle of the spent fuel assembly and the insertion tool rod is removed from the control rod guide tube.

12. The apparatus of claim 11, wherein the retainer is configured to retain the fully inserted neutron absorber member within the control rod guide tube, thereby forcing the neutron absorber member to squeeze the spring inwardly when the insertion tool rod is removed from the control rod guide tube.

13. The apparatus of claim 9, further comprising:
a neutron absorber member retainer through which the insertion tool rod extends, the retainer being configured to snap to a top nozzle of the spent fuel assembly above the control rod guide tube and retain the neutron absorber member in the control rod guide tube such that the insertion tool rod is forced to release the fully inserted neutron absorber member when the insertion tool rod is removed from the control rod guide tube.

14. The apparatus of claim 13, wherein the retainer comprises an aperture corresponding with the control rod guide tube, the aperture having a diameter that is less than a diameter of the neutron absorber member for the control rod guide tube and greater than a diameter of the insertion tool rod.

15. The apparatus of claim 14, wherein the insertion tool rod extends from the insertion tool base through the aperture of the retainer and an inner diameter of the neutron absorber member before the neutron absorber member is fully inserted into the control rod guide tube.

16. A neutron absorber member retainer for a top nozzle of a spent fuel assembly, the top nozzle comprising a surface and a plurality of ledges above the surface, the surface comprising a first portion and a second portion, the first portion being through which a control rod guide tube of the spent fuel assembly is accessible, the second portion surrounding the first portion, the ledges extending inward from an outer surface of the top nozzle, each of the ledges comprising a bottom surface facing the second portion, the retainer comprising:
a plate configured to retain a neutron absorber member inserted in the control rod guide tube; and
a plurality of flanges configured to engage bottom surfaces of the ledges and position the plate adjacent to the surface of the top nozzle.

17. The retainer of claim 16, wherein the plate comprises an aperture corresponding with the control rod guide tube, the aperture comprising a diameter that is less than a diameter of the neutron absorber member.

18. The retainer of claim 16, further comprising:
a plurality of guides configured to engage inward side surfaces of the ledges and guide the flanges into engagement with the bottom surfaces of the ledges.

19. The retainer of claim 18, wherein the flanges and the guides are positioned adjacent to outer corners of the plate.

20. The retainer of claim 18, wherein the flanges and the guides extend away from the control rod guide tube toward the ledges.

21. The retainer of claim 16, wherein the bottom surfaces of the ledges are predominantly horizontal, and
wherein the flanges are curved from an upwardly angled portion thereof to engage the bottom surface of the ledge.

22. The retainer of claim 16, wherein the flanges comprise engaging portions and extending portions, the engaging portions of the flanges being predominantly horizontal and engaging the bottom surfaces of the ledges, the extending portions of the flanges extending from the engaging portions of the flanges over the first portion, each of the extending portions of the flanges comprising a hole configured to allow a tool to disengage the engaging portions of the flanges from the bottom surfaces of the ledges.
